(19) United States
(12) Patent Application Publication
(10) Pub. No.: US 2026/0315836 A1
(43) Pub. Date: Oct. 15, 2026

(54) FACE MASK

(71) Applicant: KONINKLIJKE PHILIPS N.V., EINDHOVEN (NL)

(72) Inventors: ZHONGCHI LUO, SHANGHAI (CN); XUAN ZHANG, SHANGHAI (CN); TAO KONG, SHENZHEN (CN); FU-LUNG LIN, SHENZHEN (CN); WEI GU, SHANGHAI (CN); WEIZHONG CHEN, SHANGHAI (CN); JUN GU, SHANGHAI (CN)

(21) Appl. No.: 19/116,487

(22) PCT Filed: Sep. 27, 2023
(86) PCT No.: PCT/EP2023/076701

§ 371 Date: Mar. 28, 2025

(30) Foreign Application Priority Data
Sep. 29, 2022 (WO) PCT/CN2022/122611
Dec. 1, 2022 (EP) 22210807.8

(51) Int. Cl. A62B 18/00; A62B 18/02

(52) U.S. Cl. CPC A62B 18/006; A62B 18/025

(57) ABSTRACT

A face mask comprises a filter portion and a fan module for driving air which passes through the filter portion. A magnetic coupling is used to couple the fan module to the filter portion, The filter portion comprises a recessed area having a base wall, a non-recessed area which extends around the recessed area and a side wall extending between the recessed area and the non-recessed area. The magnetic coupling comprises first and second magnetic parts disposed on opposite faces of the side wall.

### FIELD OF THE INVENTION

This invention relates to face masks, for providing filtering of pollutants.

### BACKGROUND OF THE INVENTION

Air pollution is a worldwide concern. The World Health Organization (WHO) estimates that 4 million people die from air pollution every year. Part of this problem is the outdoor air quality in cities. Nearly 300 smog-hit cities fail to meet national air quality standards.

Official outdoor air quality standards define particle matter concentration as mass per unit volume (e.g. μg/m³). A particular concern is pollution with particles having a diameter less than 2.5 μm (termed “PM2.5”) as they are able to penetrate into the gas exchange regions of the lung (alveoli), and very small particles (<100 nm) may pass through the lungs to affect other organs.

Since this problem will not improve significantly on a short time scale, a common way to deal with this problem is to wear a mask which provides cleaner air by filtration and the market for masks in China and elsewhere has seen a great surge in recent years.

Such masks may be made of material that acts as a filter of pollutant particles, or may have a filter for only part of the mask surface, and this filter may be replaceable when it becomes clogged. However, during use, the temperature and relative humidity inside the mask increases and, combined with the pressure difference inside the mask relative to the outside, this makes breathing uncomfortable. This can be mitigated in part by providing an outlet valve or check valve which allows exhaled air to escape the mask with little resistance, but which requires inhaled air to be drawn through the filter.

To improve comfort and effectiveness, a fan can be added to the mask, this fan drawing in air through the filter and/or providing assistance when breathing out.

One possible benefit to the wearer of using a fan-powered mask is that the lungs are relieved of the slight strain caused by breathing against the resistance of the filters in a conventional non-powered mask. Furthermore, in a conventional non-powered mask, inhalation also causes a slight pressure drop within the mask which leads to leakage of the contaminants into the mask, which leakage could prove dangerous if these are toxic substances.

In one arrangement, an inlet (i.e. inhale) fan may be used to provide a continuous intake of air. In this way, the lungs are relieved of the previously mentioned slight strain caused by inhalation against the resistance of the filters in a conventional non-powered mask. A steady stream of air may then be provided to the face and may for example provide a slight positive pressure, to ensure that any leakage is outward rather than inward. However, this gives additional resistance to breathing when exhaling.

In another arrangement, an exhaust (i.e. exhale) fan may be used to provide a continuous release of air. This instead provides breathing assistance when exhaling. An exhale fan may be combined with a series check valve so that no flow can enter the mask through the fan.

The fan again creates a continuous flow of air through the mask. Air is drawn into the mask volume through the filter by the flow induced by the fan. This improves wearer comfort.

Another alternative is to provide both inlet and exhaust fans, and to time the control of the fans in synchronism with the breathing cycle of the user. The breathing cycle may be measured based on pressure (or differential pressure) measurements. This provides improved control of temperature and humidity as well as reducing the resistance to breathing for both inhalation and exhalation.

Thus, several types of mask for preventing daily exposure to air pollutants are available, including passive masks, passive masks with an exhale valve, and masks with at least one active fan.

However, during the pandemic or in medical settings, a vented mask design raises concerns that an unfiltered discharge may transmit infectious agents.

This invention relates to an active mask (i.e. with fan assistance) but with no valve, in order to ensure safety to both the wearer and environment while still providing ventilation to the wearer. Such a design needs a filtration material with low penetration and resistance, combined with a powerful fan and a coupling between them. A lower cost design becomes possible by avoiding the need for a valve and valve casing.

A magnetic coupling has been proposed attaching the fan module to the filter material, so that the fan module can easily been removed to enable cleaning of the filter material. The fan (in particular its associated electrical and electronic components) is not suitable for cleaning and does not need to be replaced as regularly as the filter.

A pair of magnetic rings can for example be placed at opposite sides of the filter material with one ring consisting of a permanent magnet and the other ring comprising a magnet or more economically a magnetizable material (e.g. iron). One of the rings is mounted on the fan around its air path and the other is a free part, so that the magnetic coupling can be formed or detached as needed.

In a basic magnetic coupling, the mating surfaces of the two magnet parts are arranged in parallel planes with the filter material sandwiched between them. However, this allows the fan module to be used way with any disposable mask and attached at any position. This may not give the intended performance.

It would be desirable to ensure correct and secure fan module positioning in this type of mask.

### SUMMARY OF THE INVENTION

The invention is defined by the claims.

According to examples in accordance with an aspect of the invention, there is provided a face mask, comprising:
a filter portion comprising filter material to filter air passing between an inner side of the face mask which faces toward the user's face during use, and an outer side of the face mask;
a fan module for arrangement in fluidic series with the filter portion for driving air which passes through the filter portion;
a magnetic coupling for releasably coupling the fan module to the filter portion in a position in fluidic series with the filter portion, wherein the magnetic coupling comprises a first magnetic part and a second magnetic part which are positioned on opposite sides of the filter portion and which are magnetically attractive to one another;
wherein the second magnetic part is comprised by the fan module;
wherein the first magnetic part is separate from the fan module;
wherein the filter portion comprises:
   a recessed area having a base wall;
   a non-recessed area which extends around the recessed area; and
   a side wall extending between the recessed area and the non-recessed area,
wherein the first and second magnetic parts are disposed on opposite faces of the side wall.

The invention relates to a mask design in which a fan drives air through the filter material (rather than through a valve). This face mask uses a magnetic coupling to attach the fan module to the filter portion. Thus, when the first and second magnetic parts are in place, magnetic attraction between the second and first magnetic parts permits magnetic coupling of the fan module to the filter portion. The fan module will be coupleable to the filter portion at a position on the mask which is defined by the position of the first magnetic part. It is noted that the magnetic parts may both be permanent magnets or one part may be a permanent magnet and the other may be a magnetizable material (i.e. ferrous material). Thus, the term “magnetic parts” should be understood accordingly.

The use of a magnetic coupling solves the problem of providing a releasable coupling that does not require permanently attached connection member on the filter. Instead the fan can be separated from the filter by applying a force against the magnetic attraction of the first magnetic component.

The shaped recess means the fan module cannot be used in uncontrolled way with any disposable mask and attached at any position. Thus, the shape features provide an economic way to ensure proper placement of the fan module and provide more secured coupling.

In a first set of examples, the recessed area extends inwardly towards the user's face. In this set of examples, the first magnetic part (the one facing the user) is on the radially outward side of the side wall and the second magnetic part (the one at the fan module) is on the radially inward side of the side wall. The first magnetic part may be held in place by the shape of the recessed area.

In a second set of examples, the recessed area extends outwardly towards the outer side of the face mask. In this set of examples, the first magnetic part (the one facing the user) is on the radially inwards side of the side wall and the second magnetic part (at the fan module) is on the radially outward side of the side wall. The first magnetic part may be held in place by adding a retaining feature.

In one set of examples, the side wall is perpendicular to a general plane of the non-recessed area. In this case, the magnetic parts comprise concentric rings with the filter portion side wall sandwiched between the magnetic parts.

In another set of examples, the side wall is oriented at an angle offset from the perpendicular to a general plane of the non-recessed area. Thus, the side wall is a sloped annular wall.

The side wall for example has a tapered ring shape.

The first and second magnetic parts for example each comprise a ring for fitting against the associated surface of the side wall.

The face mask may further comprise a retaining feature for holing the first magnetic part in place against the side wall in the absence of the second magnetic part. This make assembly and disassembly easier, by keeping the first magnetic part in place after the fan module is removed.

The recessed area for example has a non-circular shape. This means it can be ensured that the fan module fits to the filter portion with a desired orientation. The recessed area for example has a shape with rotational symmetry of 1. Thus, there is only one correct orientation of the fan module.

One of the first and second magnetic parts is larger than the other (because they are connected in a concentric arrangement). The larger magnetic part is for example segmented with elastic coupling between the segments. In this way, the larger magnetic part also applies a mechanical holding force to grip the smaller larger magnetic part, to supplement the magnetic holding force

The face mask is preferably a valve-less face mask. Thus, the fan module drives air through the filter portion rather than driving air through an opening.

The invention also provides a face mask, comprising:
a filter portion comprising filter material to filter air passing between an inner side of the face mask which faces toward the user's face during use, and an outer side of the face mask;
wherein the filter portion comprises:
   a recessed area having a base wall;
   a non-recessed area which extends around the recessed area; and
   a side wall extending between the recessed area and the non-recessed area,
wherein opposite faces of the side wall are for receiving respective first and second parts of a magnetic coupling, for attaching a fan module to the filter portion

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIGS. 1 and 2 show views of a prior art face mask having a fixed coupling between a filter member and a fan module;

FIG. 3 shows a view of another prior art face mask;

FIGS. 4 to 6 show views of a face mask with a basic implementation of a magnetic coupling between the filter portion and the fan module;

FIG. 7 shows an example of a face mask of the invention;

FIGS. 8 to 10 show three possible implementation of the magnetic coupling;

FIG. 11 shows a further optional feature for the magnetic coupling; and

FIG. 12 shows the filter used in the face mask of the invention.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a face mask which comprises a filter portion and a fan module for driving air which passes through the filter portion. A magnetic coupling is used to couple the fan module to the filter portion, The filter portion comprises a recessed area having a base wall, a non-recessed area which extends around the recessed area and a side wall extending between the recessed area and the non-recessed area. The magnetic coupling comprises first and second magnetic parts disposed on opposite faces of the side wall.

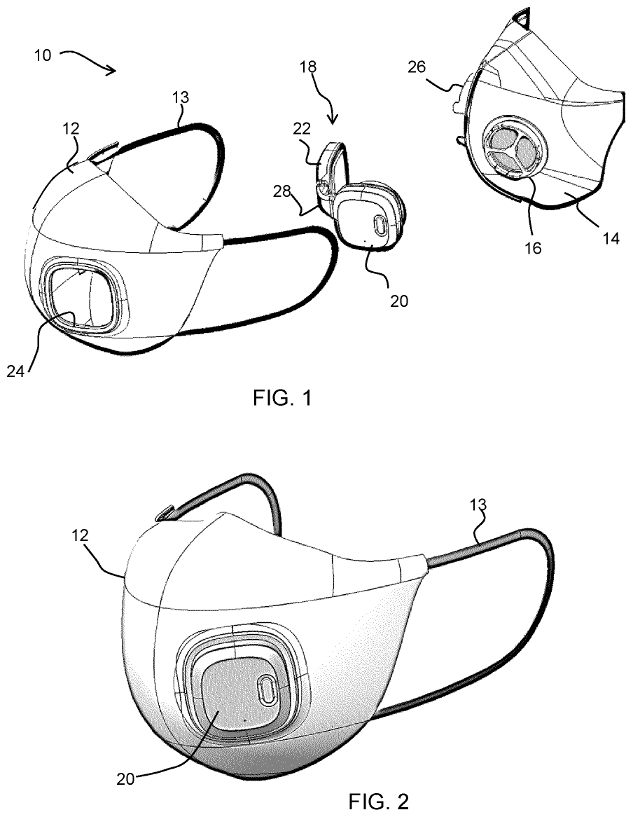

To provide context for embodiments of this invention, and also to clarify features to be described later, FIGS. 1 to 3 show two examples of prior art mask designs of which embodiments of the present invention represent an inventive development.

FIGS. 1 and 2 show a first design having an inner filter member to which a fan module is attached, and a protective outer casing.

The mask 10 is shown in exploded view and comprises the outer casing 12 and the inner filter member 14. The outer casing is rigid or semi-rigid with ear straps 13, whereas the filter member 14 is formed of a fabric and thus easily deforms such that an outer edge can match the shape of a wearer's face.

The outer casing 12 is porous so that air can flow through the outer casing. The outer casing protects the filter material from debris.

The inner filter member 14 is sealed around a connection area 16. The connection area 16 provides an area for connecting fluidly and mechanically to a fan module 20. In this particular example, the connection area 16 encompasses a passive check valve. The connection area and the fan module may be connected together and disconnected manually.

A control unit 22 is further provided and comprises for example a battery and control circuitry for controlling the fan module. This may include sensors. It may be mechanically attached to the fan module. In the illustrated example for instance, the control module 18 is coupled to the outside of the filter member 14 and the control module includes both the fan module 20 and also the control unit 22.

Note that the control circuitry may instead be integrally comprised by the fan module. Thus, the various additional circuitry elements and battery may be divided between the fan module and a dedicated control unit in different ways.

In the illustrated example, the connection area includes a physical connector module 16 which is permanently fixed to the filter member 14 so that it is discarded with the filter member 14 when there is filter replacement. The fan module 20 is reusable and includes (at least) the fan drive circuitry and fan impeller.

The outer casing 12 has an opening 24 in which the fan module 20 is received. An inner surface of the outer casing may also have a receiving dock area for the control unit 22, or else there may be a receiving dock area 26 on the outer surface of the filter member for locating the control unit 22.

An electrical connector bridge 28 provides electrical connection between the control unit 22 and the fan module 20 of the fan assembly, for transfer of power and control signals.

The fan module 20 and the control unit 22 are at opposite lateral sides of the mask, i.e. one on each side of the nose of the wearer. This provides a balanced weight distribution. By having two modules, the weight of each individual part is reduced, so that the loading at any one location is reduced.

In this example, the fan is an exhaust fan. In a most simple design, it operates continuously to provide a continuous supply of air to the face (using air drawn through the mask filter). This provides temperature and humidity control. However, it may be operated in synchronism with the breathing of the wearer (with suitable breath sensing), and it may be controlled bi-directionally.

FIG. 2 shows the design of FIG. 1 in an assembled state from one front side.

The outer casing is optional, and a lower cost design may include only the filter material and connected fan module.

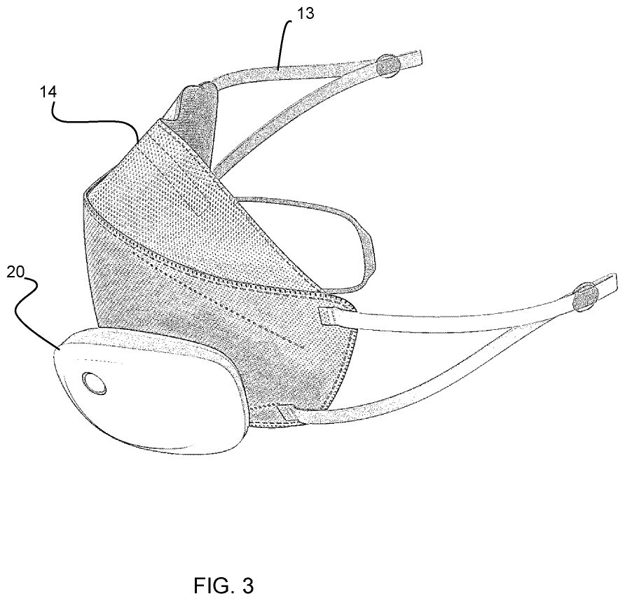

FIG. 3 shows a design without the outer casing. The fan module 20 attaches to the filter member 14 and is at the outside of the mask. One option is a magnetic coupling between a first magnetic part in the fan module and another magnetic part on the opposite side of the filter member, so that the filter member is clamped between magnetic parts which hold the fan module in place. As explained above, there is a desire to remove the venting valve, so that all air passing between the user and the ambient surroundings is filtered. The fan module 20 can for this purpose be attached directly to the filter material, i.e. there is no opening in the filter material.

The invention relates to a particular design of a magnetic coupling used to sandwich the filter material between first and second magnetic parts, wherein one magnetic part is attached to or integrated with the fan module. It is of particular interest for the type of mask device shown in FIG. 3.

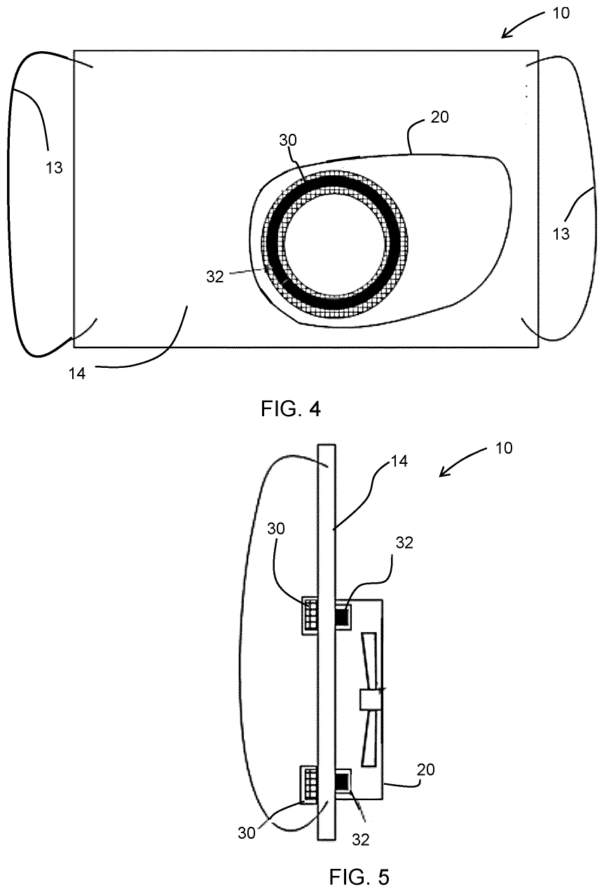

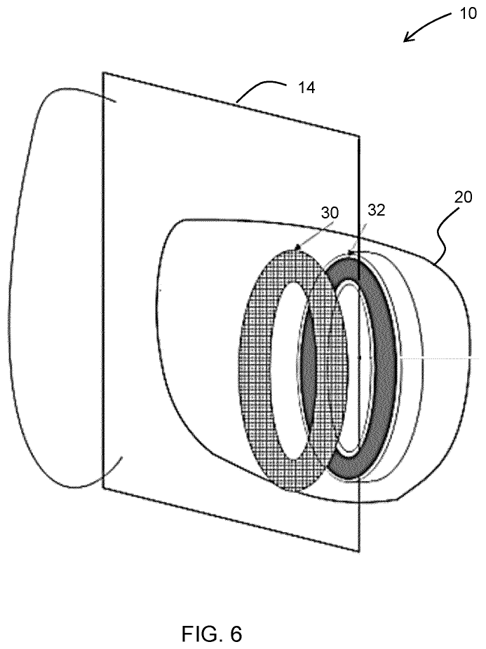

FIGS. 4 to 6 show a most basic way to implement a magnetic coupling for example suitable for the mask of FIG. 3. FIG. 4 shows the face mask from the front, FIG. 5 shows a cross sectional side view and FIG. 6 shows a perspective view.

FIGS. 4 to 5 show a face mask 10 comprising a filter portion 14 comprising filter material to filter air passing between an inner side of the face mask which faces toward the user's face during use, and an outer side of the face mask. A fan module 20 is for arrangement in fluidic series with the filter portion for driving air which passes through the filter portion.

A magnetic coupling is provided for releasably coupling the fan module to the filter portion in a position in fluidic series with the filter portion. The magnetic coupling comprises a first magnetic part 30 and a second magnetic part 32 which are positioned on opposite sides of the filter portion 14 and which are magnetically attractive to one another.

The first magnetic part 30 is a ring which is bonded to the filter portion or it may be a loose ring. It is separate from the fan module. The second magnetic part 32 is comprised by the fan module 20.

In this design, the mating surfaces of the magnetic parts are arranged in two planes essentially parallel to the plane of the enclosed filter fabric. However, this allows the fan unit to be used with any disposable mask and attached at any position. This invention proposes an economic way to ensure proper placement of the fan and provide more secure coupling.

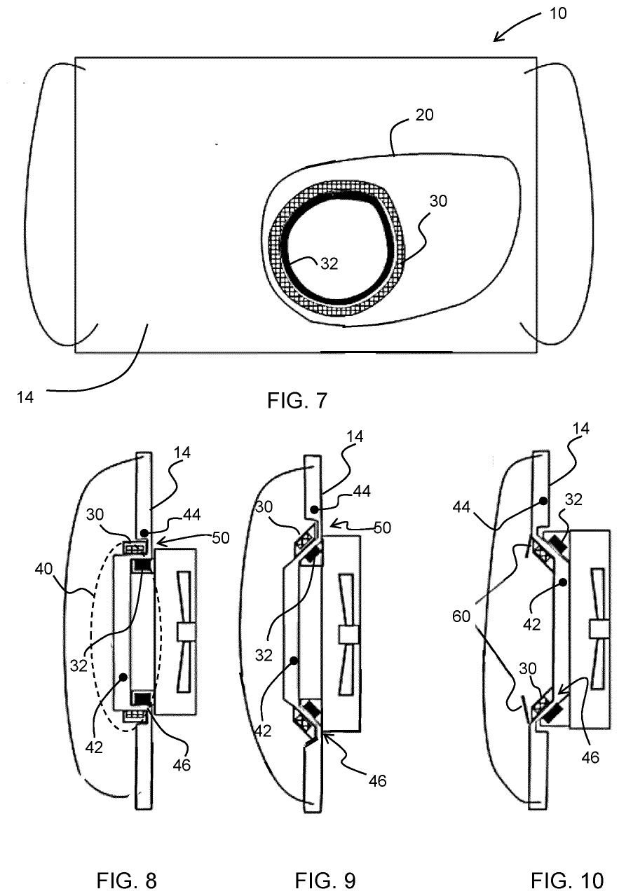

FIG. 7 shows a mask in accordance with the invention from the front. The mask is generally the same as in FIG. 4. However, FIG. 7 also shows that the magnetic parts have a non-circular shape, and in particular a shape which only allows the magnetic parts to mate with the shape of the recessed area in one desired orientation as well as location.

FIGS. 8 to 10 show three possible implementations of the invention.

FIG. 8 shows that the filter portion comprises a recessed area 40 having a base wall 42. A non-recessed area 44 extends around the recessed area and a side wall 46 extends between the recessed area and the non-recessed area. The recessed area is for example formed by hot pressing.

The first and second magnetic parts 30, 32 are disposed on opposite faces of the side wall. They each comprise a ring. In the example of FIG. 8, the recessed area 40 extends inwardly towards the user's face. In other words, the base wall 42 is pressed inwardly relative to the rest of the filter material layer.

In the example of FIG. 8, the side wall 46 is perpendicular to the base 42. This means the magnetic parts are concentric with the first magnetic part 30 disposed around the outside of the second magnetic part 32 with the filter material layer sandwiched between them.

A notch 50 is formed for retaining the first magnetic part 30, so that when the fan module and its second magnetic part is removed (by pulling it away from the mask) the first magnetic part remains in place and does not fall off the filter portion.

FIG. 9 shows a second example.

In the example of FIG. 9, the recessed area 40 again extends inwardly towards the user's face. However, the side wall 46 is oriented at an angle offset from the perpendicular to a general plane of the non-recessed area. The side wall in particular has a tapered ring shape. There is again a notch for holding the first magnetic part 30.

The magnetic parts again each comprise a ring. The tapered side wall for example has a taper angle to the general plane of the filter portion in the range 30 to 60 degrees.

FIG. 10 shows a third example.

In the example of FIG. 10, the recessed area 40 extends outwardly away from the user's face. As in FIG. 9, the side wall 46 is oriented at an angle offset from the perpendicular to a general plane of the non-recessed area. The side wall again has a tapered ring shape.

In this design an optional addition feature is shown of a retaining feature 60 for holing the first magnetic part 30 in place against the side wall in the absence of the second magnetic part.

These retaining features are designed such that when detaching the magnetic coupling by pulling the fan module outward, the inside part of the magnetic coupling (i.e. the first magnetic part) does not fall.

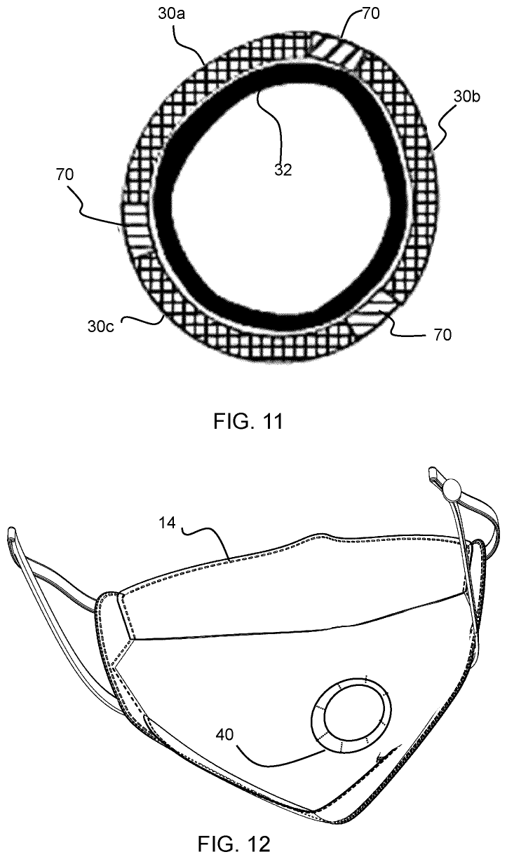

To ensure a more secure and tight coupling, the larger one of the two magnetic parts can be partitioned into a plurality of segments linked by elastic materials. This concept is shown in FIG. 11.

The first magnetic part is assumed to be the larger one (as in FIGS. 8 and 9) and it is segmented into three parts 30a, 30b, 30c which are pulled together by elastic couplings 70 between the segments.

When the magnetic coupling is formed, the elastic coupling stretch so that a retaining force is generated that helps to hold the magnetic coupling together. The elastic couplings are for example rubber.

FIG. 12 shows the filter member 14 with a recessed area 40 which extends inwardly towards the user's face.

In all these designs, to assemble the mask, the smaller magnetic part is placed in position and the larger magnetic part is then placed over the side wall facing the smaller counterpart to form the magnetic coupling. The opposite is performed for disassembling.

The second and first magnetic parts may each include one or more magnets, wherein the magnet(s) of the second part are magnetically attracted to the magnets of the first part. Alternatively, one of the second and first magnetic parts may include one or more magnets, and the other may include magnetic material attractive to the magnet(s) of the other part. With regards to the magnets, a plurality of magnetic elements may be included in one or both of the magnetic parts of the coupling, or just one. One or more magnetic strips might be used in some examples.

As will be understood from FIGS. 1 and 2, the mask can optionally include an outer cover portion which is layered over the filter portion 14, for protection. For example, the outer cover portion may be rigid or semi-rigid with ear straps 13, whereas the filter member 14 may be formed of a fabric and thus easily deforms such that an outer edge can match the shape of a wearer's face. More preferably however, the mask comprises the filter portion without such an outer covering, to minimize resistance against the breathing of the user and to reduce cost. Ear bands may be attached to the filter portion to permit wearing of the face mask in the usual way. The filter portion comprises a filter material and different grades of filtration are possible.

The fan module may be a self-contained modular unit which contains a fan motor, fan impeller for driving air, a battery, and control electronics for driving the fan. The control circuitry may further include sensors.

The fan module may be an inward fan. In a most simple design, it operates continuously to provide a continuous supply of air to the face (using air drawn through the mask filter). This provides temperature and humidity control. However, it may alternatively be operated in synchronism with the breathing of the wearer (with suitable breath sensing), and it may be controlled bi-directionally.

For example, when breathing in, air is drawn through the filter portion 14. The fan may be operating during this time, providing an airflow, or it may be turned off to save power. When breathing out, the fan may operate to create outward flow. Breathing comfort is improved particularly because the fan removes the exhaled air from the mask cavity and therefore prevents re-breathing (recycling) of previously exhaled and hence un-fresh air.

The filter material has sufficient rigidity to retain its shape and thereby maintain the local shape of the recessed area. However, it also has sufficient flexibility that it can be deformed slightly from its default rest shape to a shape that fits the face of different possible users.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A face mask with a fan module comprising:
a filter portion comprising filter material to filter air passing between an inner side of the face mask which faces toward the user's face during use, and an outer side of the face mask;
the fan module for arrangement in fluidic series with the filter portion for driving air which passes through the filter portion;
a magnetic coupling for releasably coupling the fan module to the filter portion in a position in fluidic series with the filter portion, wherein the magnetic coupling comprises a first magnetic part and a second magnetic part which are positioned on opposite sides of the filter portion and which are magnetically attractive to one another;
characterized in that the second magnetic part is comprised by the fan module;
wherein the first magnetic part is separate from the fan module;
wherein the filter portion comprises:
a recessed area having a base wall
a non-recessed area which extends around the recessed area; and
a side wall extending between the recessed area and the non-recessed area,
wherein the first and second magnetic parts are disposed on opposite faces of the side wall.

2. The face mask of claim 1, wherein the recessed area extends inwardly towards the user's face.

3. The face mask of claim 1, wherein the recessed area extends outwardly towards the outer side of the face mask.

4. The face mask of claim 1, wherein the side wall is perpendicular to a general plane of the non-recessed area.

5. The face mask of claim 1, wherein the side wall is oriented at an angle offset from the perpendicular to a general plane of the non-recessed area.

6. The face mask of claim 5, wherein the side wall has a tapered ring shape.

7. The face mask of claim 1, wherein the first and second magnetic parts each comprise a ring.

8. The face mask of claim 1, further comprising a retaining feature for holing the first magnetic part in place against the side wall in the absence of the second magnetic part.

9. The face mask of claim 1, wherein the recessed area has a non-circular shape.

10. The face mask of claim 9, wherein the recessed area has a shape with rotational symmetry of order one.

11. The face mask of claim 1, wherein one of the first and second magnetic parts is larger than the other, wherein the larger magnetic part is segmented with elastic coupling between the segments.

12. The face mask of claim 1, comprising a valve-less face mask.

13. A face mask, comprising:
a filter portion comprising filter material to filter air passing between an inner side of the face mask which faces toward the user's face during use, and an outer side of the face mask;
wherein the filter portion comprises:
a recessed area having a base wall
a non-recessed area which extends around the recessed area; and
a side wall extending between the recessed area and the non-recessed area,
wherein opposite faces of the side wall are for receiving respective first and second parts of a magnetic coupling, for attaching a fan module to the filter portion.
